(19) United States
(12) Patent Application Publication
(10) Pub. No.: US 2009/0040877 A1
(43) Pub. Date: Feb. 12, 2009

(54) PORTABLE TIMEPIECE AND ALARM LINKED TO SCHEDULED EVENTS

(75) Inventors: Patrick C. McGeough, Carnegie, PA (US); Adam D. Pennington, Irvington, NY (US)

Correspondence Address: HESLIN ROTHENBERG FARLEY & MESITI PC, 5 COLUMBIA CIRCLE, ALBANY, NY, 12203, US

(73) Assignee: GAME TIME, LLC, Fishkill, NY (US)

(21) Appl. No.: 11/836,893

(22) Filed: Aug. 10, 2007

(51) Int. Cl. G04C 21/34

(52) U.S. Cl. 368/73

(57) ABSTRACT

A portable electronic device is provided with the capability of accepting downloaded data. In particular, the data represents sports team schedule information so as to provide the user with an alarm indicating the start of his or her favorite team's game time. The device is also provided with audio playback for associated audio tracks such as the team song or a song associated with a team sport. The device is also capable of displaying downloaded team pictorial data such as its logo or emblem.

### TECHNICAL FIELD

This invention relates in general to portable time and alarm devices, and more particularly, to watches. More particularly, the present invention is directed to watches which are capable of displaying event related information, particularly information relating to sporting or similar events. Even more particularly, the present invention is directed to a watch which is capable of downloading event related information for events that are scheduled to take place in the future.

### BACKGROUND OF THE INVENTION

The device of the present invention is most closely related to the time and alarm device illustrated in U.S. Pat. No. 6,414,907 issued Jul. 2, 2002. This device is capable of signaling to the user the start of an event such as a scheduled baseball game. In particular, the signal may comprise the playing of a stored song or tune such as “Take Me Out to the Ballgame.” However, the device must somehow “know” the time, the date, and the details relating to various specific sporting events. In the device described in the aforementioned patent, the information is provided by means of a replaceable module. In this patented device, the watch is opened, the old module is removed and an updated module is inserted. Updating of this device requires module replacement on an annual or seasonal basis. Clearly this is inconvenient for the user. However, it is noted that the updating operation is necessary since events are rarely scheduled more than a year in advance or for the next season.

Additionally it is noted that advances in storage capability have made it possible to add additional functionality to devices of the present kind. It is further noted that advances in computers, the Internet and software for downloading and transferring information have also occurred. In particular, it has been seen that since the above-mentioned patent was filed, the use of the USB standard has proliferated. This standard describes the signal wires and the form factors for various connectors that are intended for use with this standard. However, the usual USB standard connectors are not employable in the context of providing connections to a device such as a watch. There are several reasons for this circumstance. The first reason is that the standard USB connectors are either too thick fat or wide to be easily inserted into a corresponding structure present on a device having the size and scale of a watch. Furthermore, since it is desirable that watch devices exhibit a degree of water resistance, standard USB connectors cannot be employed. This is a particularly important factor in the design of the present invention since it is anticipated that many of its users will be sporting fans who might be quiet in the rain at the stadium where the event is occurring.

### SUMMARY OF THE INVENTION

In accordance with a preferred embodiment of the present invention a portable clock device, such as a wrist watch comprises: an oscillator based timer; a processor for receiving time and date information from the timer; a memory coupled to the processor; a display, driven by the processor for displaying time, date and stored information from the memory, the information being related to event times stored in said memory; an alarm actuatable by said processor at a time determined by said stored event times; and a plurality of externally accessible contacts for transferring the event related information from an external source to the memory.

In accordance with another aspect of the present invention, a sporting events watch is provided with external contacts through which a team's annual schedule may be downloaded. The downloaded event schedule is stored and used to initiate the playing of a team (professional or college level) song upon the occurrence of an event or at a predetermined time before the event. A portion of the display is also allocated to the display of a team logo, emblem or insignia. Time zone information relating to the event is also displayed since it is contemplated that the user/wearer may not be home-based in the same time zone as their favorite team whose schedule the watch is being used to track. The time zone shown is not limited to the four standard US time zones but includes any time zone in the world.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a top view of the face of a watch representing an embodiment of the present invention;

FIG. 2 is a stylized enlargement of the display shown in FIG. 1 but showing more detail than is convenient for FIG. 1;

FIG. 3 is a view showing the back of the watch shown in FIG. 1 so as to more particularly show contacts for downloading data such as team schedules;

FIG. 4 is a top view similar to FIG. 1 but more particularly illustrating a data clamp mechanism already in position for connecting a USB cable to the device;

FIG. 5 is a side view of the data clamp mechanism shown in FIG. 4 showing the data clamp in its fully closed position with its pins (not visible in this view) in electrical contact with corresponding contacts (see FIG. 3) on the device;

FIG. 6 is a view similar to FIG. 5 but which shows the data clamp in an open position with its pins and alignment bump now visible;

FIG. 7 is a view of the data clamp in an open position showing the layout of its pins for mating with watch contacts;

FIG. 8 is a view of the data clamp together with a USB connector and a case for retraction and storage of the connection cord;

FIG. 9 is a schematic diagram illustrating the component systems of the present invention; and

FIG. 10 is a schematic diagram illustrating in greater detail connections made to a processor chip for controlling the operation of the present device.

### DETAILED DESCRIPTION

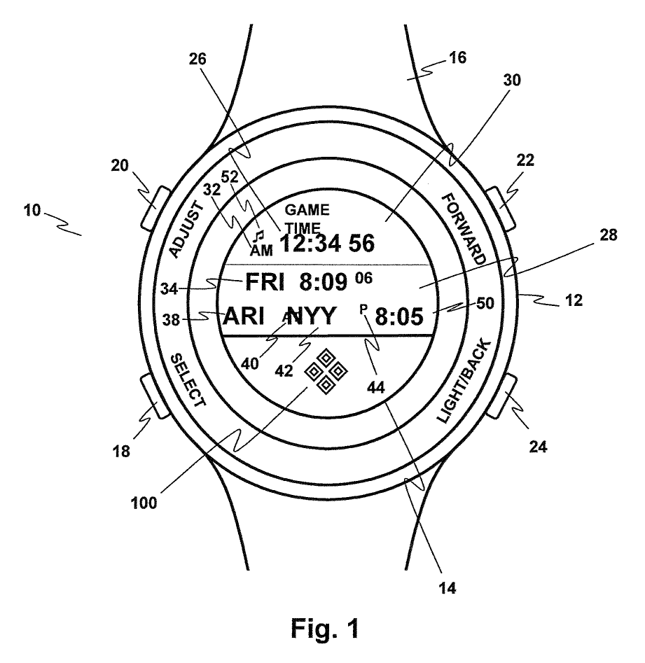

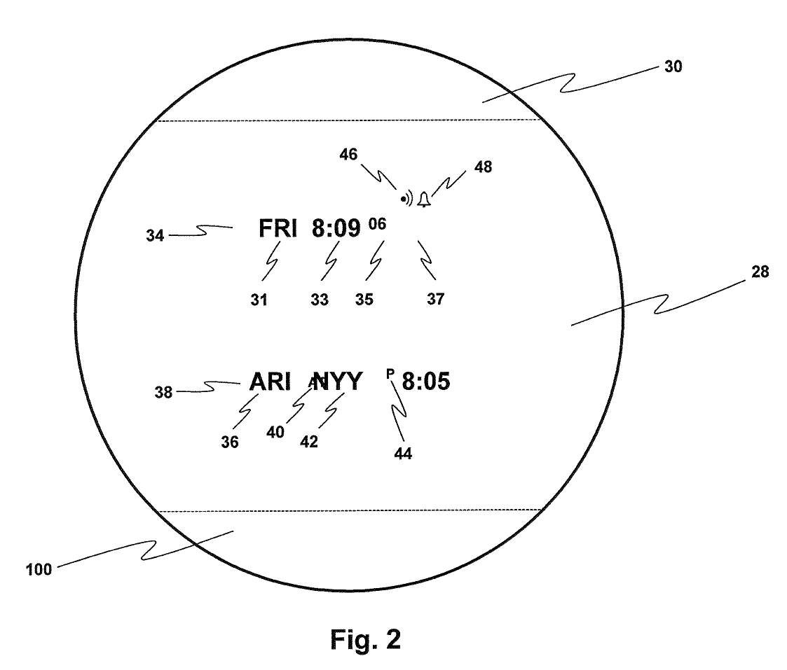

FIG. 1 illustrates an embodiment in a wrist watch form of the present invention. In particular, FIG. 1 illustrates a portable electronic device 10 with a wrist strap 16. The device is provided with for external button switches used for controlling the device. In particular button 20 is labeled “adjust,” but in 18 is labeled “select” and buttons 22 and 24 provide forward and backward functionality for adjusting time, date and various other informational items displayed on the watch face. But in 24 also functions to activate a light for the display. It is furthermore noted that device 10 includes a display of 14 which is divided into three different functional areas. The upper area of display 14 (reference numeral 30) lying above the dotted line (not present in the actual watch but only provided for convenient description of the different functional areas) is employed to provide a conventional time display. It is also noted that this section of display 14 also includes melody indicator 52, shown in the top left of the display (musical notes) in FIG. 1. This indicator is turned on/off within the same function as the chime and alarm. It determines whether or not a song plays at game (more generically, event) time. Portion 28 of display 14 below the dotted line is employed to provide information relevant to scheduled events. This information is also described in greater detail in FIG. 2 which is more particularly described below. The first line of area 28 provides the day of the week information, followed by month date and year information relevant to an event.

In order to best appreciate the functioning and operation of the present invention, it is useful to consider the events as being sporting matches between competing teams. For example, the present invention is usable to determine the time and date of a future match between two baseball teams. With respect to this functionality, it is noted that the second line of area 28 indicates, in an abbreviated form, the teams that are playing and the start time of the game. In particular, it is noted that, as illustrated in FIG. 1, line 38 indicates that Arizona is playing the New York Yankees at New York with indicator 44 further pointing out the fact that this particular game is scheduled for a “PM” time. Start time indicator 50 thus shows that the game starts at 8:05 PM.

Is noted that display 14 includes a third region 100 which is employed to display team logos, emblems or insignia. Solely for the sake of example the emblem illustrated in FIG. 1 is a selected to represent a fictitious baseball team that might call themselves the “Diamond Dogs.” The information that is displayed in region 30 of display 14 is thus seen to represent standard Time and/or date information. Region 28 of display 14 is provided to indicate the day, the date, the time and the two teams scheduled to play. Display region 28 is also preferably provided with an indication 40 of which one of the two teams is the home team. This is a particularly useful indicator if the event being displayed is a major league baseball game. In baseball, doubleheaders are common while in other sports they are not. In those circumstances indicator 44 may serve another function.

In contrast to the device described in the abovementioned patent, the present device receives the information shown in areas 28 and 100 from an Internet download operation. In a typical operation, a user of the watch logs on to a website belonging to the device manufacturer or distributor. A simple mouse click causes schedule data for which a subscription has been issued to be downloaded through a USB port. The downloaded information not only includes team is scheduled data but also includes audio data associated with the particular team. For example, if the team is a college football team downloaded information includes audio data representing the teams fight song. Additionally, the downloaded data also includes, under appropriate circumstances, video information associated with the team such as the team logo or even a picture of the team mascot. This latter information is displayed in portion 100 of display 14.

Since space and size limitations in FIG. 1 reduced the level of detail which could be easily shown and pointed out by reference numerals, FIG. 2 is provided. However it is noted that FIG. 2 is not drawn to scale and in particular the size of regions 30 and 100 have been reduced so as to make the inclusion of reference numerals more visible and less confusing. More particularly, it is seen that region 28 of display 14 includes two lines, line 34 indicating the time of the event and line 38 indicating the players and the event location.

Line 34 in display portion 28 includes day of the week indicator 31, month indicator 33, date indicator 35 and year indicator 37. Line 34 also includes two alarm indicators. Miscellaneous alarm indicator 46 corresponds to an electronic watches usual alarm function. This indicator is displayed as shown in the event that an alarm has been set by the user. Additionally, there is also provided event alarm 48 which gives an indication that alarms for upcoming events are to be recognized.

Line 38 in display 14 includes a first indicator 36 which indicates a first team and a second indicator 42 which indicates the opposing team. Additionally, playing location indicator 40 is provided to indicate where the game is being played, it being understood that the home team is listed by indicator 42. Supplemental or miscellaneous indicator 44 is provided to denote special circumstances such as doubleheaders as described above. Lastly, line 38 indicates a time before the event in terms of hours and minutes, it being particularly noted that figure to indicates a time of 8:05 p.m.

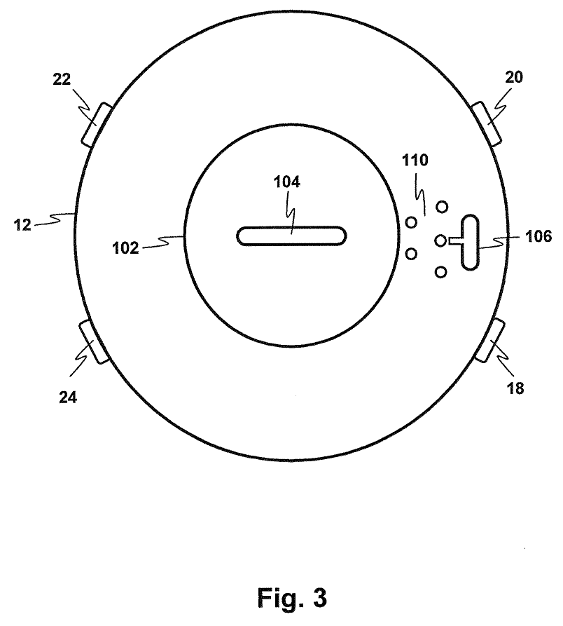

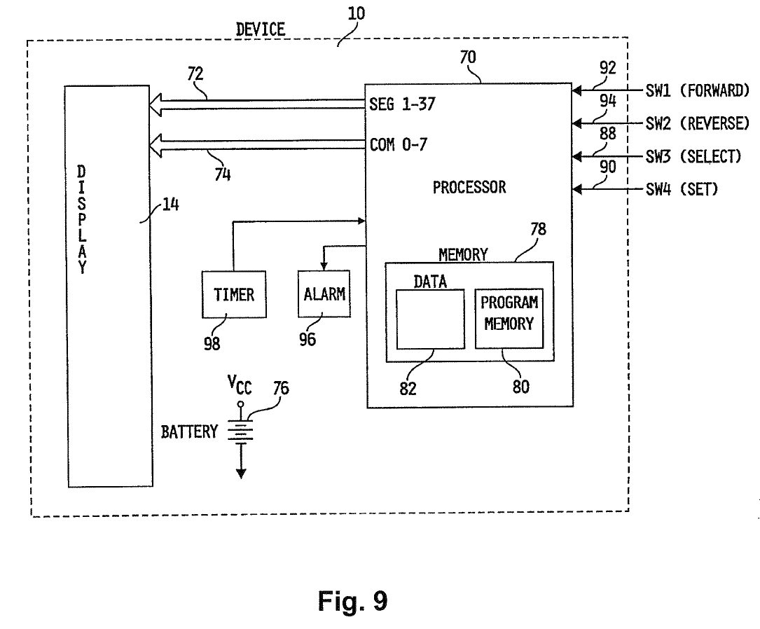

FIG. 3 illustrates the backside of device 10. For purposes of clarity strap 16 is not shown. FIG. 13 is intended to show three significant aspects of the present invention. In particular, FIG. 3 illustrates the presence of battery cover 102 which includes slot 104 which is designed as a but a coin such as a dime may be inserted to on screw cover plate 102 for purposes of changing the devices battery. Also of importance in FIG. 2 contacts 110 are shown. These contacts are significant for the present invention since they provide an external mechanism for storing data into the internal device memory (see FIG. 9) without the need for module exchange as is required in the patent mentioned above. As shown in FIG. 3, five contacts are provided arranged as shown. These contacts provide a sealed electrical connection from the outside of the device 10 to its inside. Additionally, FIG. 3 illustrates the presence of alignment depression 106 which is designed to mate with information data clamp 200. This depression matches and a corresponding protrusion on clamp 200 to assure proper alignment between device 10 and clamp 200 during information downloading.

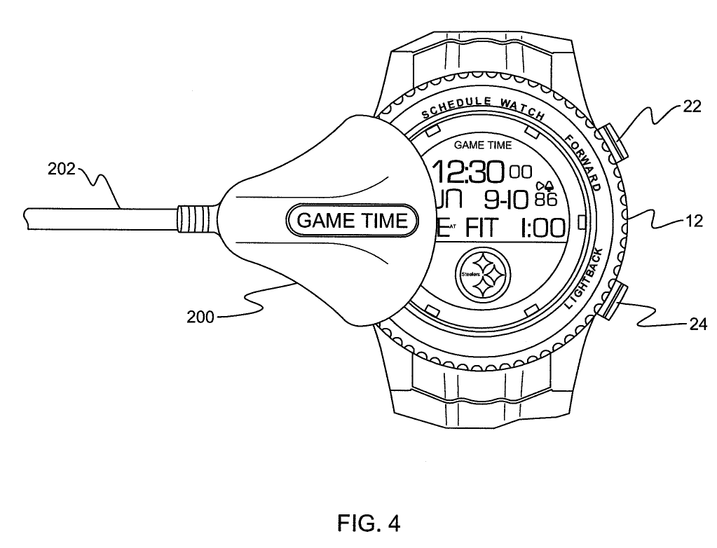

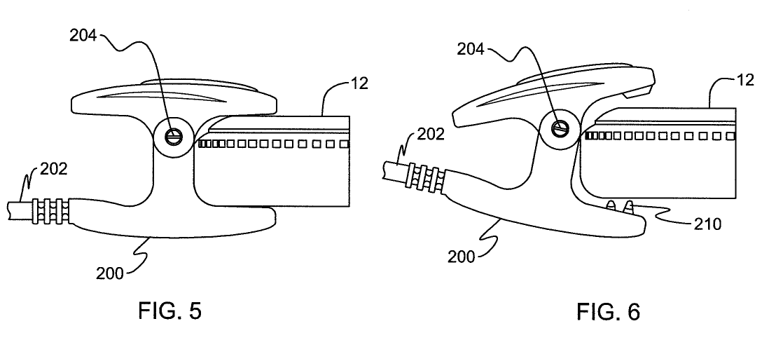

FIG. 4 illustrates information clamp 200 disposed in contact with device 10 disposed within the housing 12. Clamp 200 includes insulated wires 202 extending to a conventional USB port connector. Clamp 200 is not a standard USB port connector. Further details pertaining to the function and operation of clamp 200 are shown in FIGS. 5 and 6. Clamp 200 is provided with a spring (not visible) designed to provide a biasing force urging the jaws of clamp 200 together. In FIG. 5, clamp 200 is shown in a side elevation view disposed in a position for which data transfer is rendered possible. In contrast, in FIG. 6 the jaws of clamps 200 are shown in the open position so as to render more visible pins 210 which are configured to mate with contacts 110. Also shown in FIG. 6 is protrusion 206 which is designed to mate with depression 106.

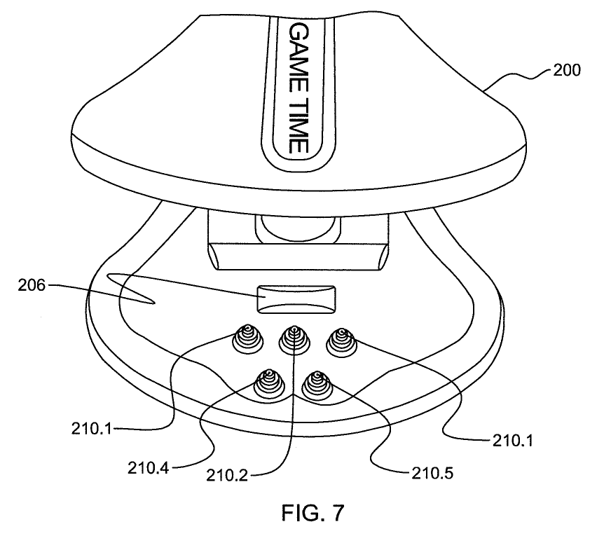

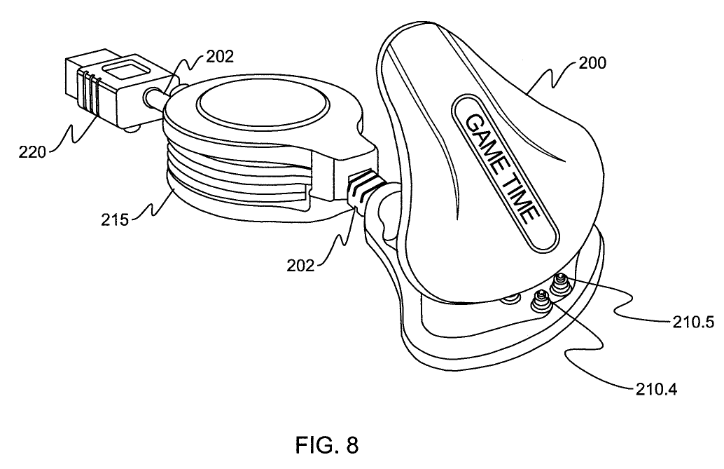

FIG. 7 provides yet another view of clamp 200. In this drawing, pins to 10 are clearly visible and are more specifically labeled as 210.1 through 210.5, as shown. Additionally, protrusion 206 is seen to be provided so as to match depression 106 in device 10. Clearly the roles of depression and protrusion as between the clamp and the device can be reversed. Yet another view of information clamp 200 is provided in FIG. 8. In this figure, cord 202 is seen to be provided with spring driven take-up reel 215 which is supplied for convenience. Lastly cord 202 is seen to be provided with conventional USB port terminator 220.

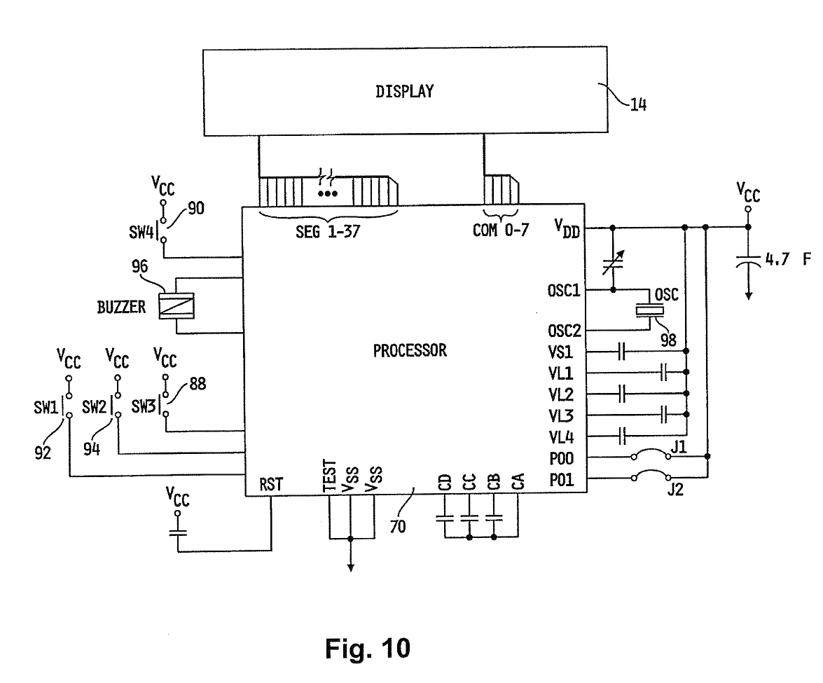

As shown in the block diagram of FIG. 9, device 10 includes processor 70 or micro-controller, which, in an exemplary embodiment, is a 4-bit single-chip device with a ⅛ duty cycle direct, 320 segment display drive (such as Samsung Part No. KS57C2504). Processor 70 is connected to display 14 over segment driver lines 72 and COM lines 74. Battery 76 provides power (V_{cc}) to device 10. Processor 70 includes a 4000 byte internal ROM memory 78 which contains application programming 80 and data representing schedule and audio tune information 82. Switches 88, 90, 92 and 94 are connected to select switch 18, set switch 20, forward switch 22, and reverse switch 24, respectively. Alarm 96 and oscillator 98 are connected to processor 70. FIG. 10 provides a view similar to FIG. 9 but is more particularly directed to electrical connections relevant to processor 70.

While the device described above is characterized as a wrist watch, it is also contemplated that the present invention may also be provided in the form of a pocket watch or some other device such as a PDA (Personal Digital Assistant). Furthermore, while the functionality of the device described above is presented in terms of its use with team sporting events such as baseball, football, soccer, hockey or basketball, it is also usable in connection with racing events such as NASCAR and for performances by a particular performing group or person. Any set of events having predetermined occurrence times may be downloaded and stored in the device for future notification.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

1. A watch comprising:
an oscillator based timer;
a processor for receiving time and date information from said timer;
a memory coupled to said processor;
a display, driven by said processor for displaying time, date and stored information from said memory, said information being related to event times, representing schedule information for at least one team selected by a user of said watch, and which is stored in said memory;
an alarm actuatable by said processor at a time determined by said stored event times, said alarm including audio, previously stored in said memory and associated with at least one of said event times and with said at least one team; and
a plurality of externally accessible electrical contacts for transferring said event related information and said audio from an external source to said memory.

2. (canceled)

3. The device of claim 1 in which said watch is a wrist watch.

4. The device of claim 1 in which said watch is a pocket watch.

5. (canceled)

6. The device of claim 1 in which said events are sporting events.

7. The device of claim 6 in which a portion of said display is allocated to displaying a team insignia from data stored in said memory.

8. The device of claim 1 further including an external clamp having pins positionally matching said contacts and affixed to said device so as to provide electrical connections between respective ones of said pins and said contacts.

9. The device of claim 1 in which said memory includes executable programming responsive to external switches on said watch to display team schedules for a user selectable period of time.

10. A watch comprising:
an oscillator based timer;
a processor for receiving time and date information from said timer;
a memory coupled to said processor;
a display, driven by said processor for displaying time, date and stored information from said memory, said information being related to event times, representing schedule information for at least one team selected by a user of said watch, and which is stored in said memory;
an alarm actuatable by said processor at a time determined by said stored event times;
a plurality of externally accessible electrical contacts for transferring said event related information and said audio from an external source to said memory; and
data stored in said memory representing audio material associated with at least one of said event times and with said at least one team.

11. The device of claim 10 in which at least one of said event times is a game time.

12. (canceled)

13. The watch of claim 1 in which said at least one event times is for a competitive team event.

14. The watch of claim 1 in which said event times represent season schedules for at least one competitive team.

15. The watch of claim 1 in which said event times represent season schedules for at least one competitive team which is selectable by a user of said watch.
